(19) United States
(12) Patent Application Publication
(10) Pub. No.: US 2026/0073506 A1
(43) Pub. Date: Mar. 12, 2026

(54) ARTICLE INSPECTION DEVICE

(71) Applicant: ANRITSU CORPORATION, Kanagawa (JP)

(72) Inventors: Takeshi YAMAZAKI, Kanagawa (JP); Koetsu TSUNODA, Kanagawa (JP)

(21) Appl. No.: 19/316,230

(22) Filed: Sep. 2, 2025

(30) Foreign Application Priority Data
Sep. 10, 2024 (JP) 2024-156759

(51) Int. Cl. G06T 7/00; G06V 10/764; G06V 10/774; G06V 10/776

(52) U.S. Cl. CPC G06T 7/001; G06V 10/764; G06V 10/774; G06V 10/776; G06T 2207/10116; G06T 2207/20076; G06T 2207/30128

(57) ABSTRACT

An article inspection device capable of increasing accuracy of learning or performance verification without an effort to acquire an inspection image to be used for learning or performance verification for setting an inspection condition is provided. An article inspection device includes an inspection unit that inspects a quality state of an article using an inspection image obtained by imaging the article being transported, in which the inspection unit sets an inspection condition of the quality state of the article based on a pseudo-image of the inspection image generated by a generative AI. The inspection unit inspects the quality state of the article by applying a trained model as an inspection condition created by learning the pseudo-image.

### TECHNICAL FIELD

The present invention relates to an article inspection device, and particularly to an article inspection device that inspects a quality state of an article using an inspection image obtained by imaging an inspection object and a learning model or an inspection algorithm.

### BACKGROUND ART

Recently, an article inspection device that inspects a quality state of an article by applying a so-called artificial intelligence (AI) model, which is a machine-trained model, or using an inspection algorithm for an inspection image or a sensor signal including a feature value corresponding to the quality state of the article, and outputs an image including inspection result information by displaying the image as the inspection image has been known.

For example, such an article inspection device includes an information accumulation unit that stores a plurality of types of image processing algorithms, a setting operation unit that selects a foreign object detection characteristic indicating detection performance of a foreign object to be detected in an inspection object, a control unit that extracts at least one image processing algorithm approximating to the selected foreign object detection characteristic from the information accumulation unit, and a display unit that displays the extracted image processing algorithm in a predetermined form, in which a setting operation of an optimal image processing algorithm can be easily executed (for example, see Patent Document 1).

In order to improve accuracy of article inspection, an article inspection device captures a plurality of images provided through different input channels under a predetermined imaging condition corresponding to each input channel, acquires image data of the plurality of images of the inspection object as a set, and stores the image data in an image storage unit. The article inspection device creates a trained model for inspection determination that is machine-trained using training image data acquired under the same imaging condition as the image data of the inspection object stored in the image storage unit, and obtains a quality defect degree by processing the image data of the inspection object acquired during the actual inspection for each pixel using the model and determines the quality state of the inspection object by comparing the quality defect degree with a threshold value set in advance (for example, see Patent Document 2).

An article inspection device includes an X-ray generator, an X-ray detector, a determination unit that determines a quality state of an inspection object, an X-ray image storage unit that stores image data from the X-ray detector, and an image creation unit that includes a pseudo-image generation model for generating pseudo-X-ray image data in another energy band based on a learning result of X-ray image data in a plurality of different energy bands related to a learning target article type and that creates a pseudo-transmission image in the other energy band using the pseudo-image generation model based on X-ray image data of the inspection object, in which the determination unit executes determination based on X-ray image data of a predetermined energy band and on a pseudo transmission image in the other energy band created by the image creation unit (for example, see Patent Document 3).

### RELATED ART DOCUMENT

### Patent Document

[Patent Document 1] JP-A-2012-137387
[Patent Document 2] JP-A-2023-114828
[Patent Document 3] JP-A-2021-148486

### DISCLOSURE OF THE INVENTION

### Problem that the Invention is to Solve

In any of the above article inspection devices of the related art, in a case where variation in products determined as a normal product is significant or the number of types of defects such as a foreign object is large, a large number of images are necessary. Particularly, for example, in the article inspection device equipped with an image inspection function using AI, even in a case where only a normal product image of a product is used as an image for learning, an image of a defective product such as a contained foreign object or a defective product image having a product shape defect needs to be acquired from various spots together with the normal product image. Thus, more images are necessary.

Meanwhile, for example, an inspection device using a camera or an X-ray image can easily create an image of a product containing a foreign object by preparing an image of only the foreign object and compositing the image of the foreign object with a normal product image.

However, in an article manufacturing line, what kind of foreign object is contained or what kind of defect occurs in the product cannot be perceived in advance. For example, for a bone foreign object that may be contained in meat, since bones cut together in cutting meat have various shapes, it is difficult to prepare images for learning corresponding to all of the shapes. Thus, a large number of images for learning are required.

Even for a normal product, in a case where the normal product is a cooked food or a stuffed processed food, variation in sizes or shapes of individual contents is present compared to a normal industrial product. In a case where the contents overlap with each other in a bagged product, completely different inspection images are obtained depending on a degree of overlapping. Thus, even in this case, a large number of images for learning are required.

In a case where a defective product having an abnormal shape is detected, a frequency with which the defective product occurs is generally low, and it is generally difficult to prepare a real object. Thus, even in a case where a shape defect is reproduced through image processing, a problem arises in that a defective product image having a fragmentation or a distorted shape in a natural form is not easily created.

Meanwhile, in a case where the article inspection device is equipped with the image inspection function using artificial intelligence (AI) or performance verification of the image inspection function is executed, or in a case where the inspection image is used for the performance verification through rule-based processing, the accuracy of the learning or the performance verification needs to be increased by using foreign object images or defective product images having as many patterns as possible without bias. Thus, in the article inspection device of the related art, an inspection condition cannot be set with a small number of images, and an effort to acquire the inspection image to be used for the learning or the performance verification and set the inspection condition based on the inspection image is required.

Therefore, an object of the present invention is to provide an article inspection device capable of increasing accuracy of learning or performance verification without an effort to acquire an inspection image to be used for learning or performance verification for setting an inspection condition of article inspection.

### Means for Solving the Problem

(1) In order to achieve the above object, an article inspection device according to the present invention includes an inspection unit that inspects a quality state of an article using an inspection image obtained by imaging the article being transported, in which the inspection unit sets an inspection condition of the quality state of the article based on a pseudo-image of the inspection image generated by a generative AI.

In the present invention, with the above configuration, the pseudo-image of the inspection image is generated by the generative AI in order to set the inspection condition for the quality state of the article. Thus, multiple pseudo-images can be easily generated as simulated images of each of diverse inspection images (may be segmentation images) by taking variation in size or shape including a fragmentation or distortion of an inspection target article or variation such as diverse disposition and shapes of contents of the inspection target article or a shape, a size, or the like of a contained foreign object that cannot be predicted into consideration. Accordingly, data augmentation of an effective original image for setting the inspection condition can be performed, and accuracy of machine learning or performance verification can be effectively increased.
(2) In a preferred embodiment of the present invention, the inspection unit may set the inspection condition using a trained model created by learning the pseudo-image.

In this case, in a learning phase of the trained model, diverse variation in shape including a fragmentation, distortion, or the like of the inspection target product, diverse disposition or shapes of the contents of the inspection target product, furthermore, a shape, a size, or the like of the contained foreign object that cannot be predicted can be learned without bias, and required accuracy in model learning or the performance verification is secured.
(3) In a preferred embodiment of the present invention, the article inspection device may further include an image processing algorithm storage unit that stores a plurality of image processing algorithms in advance, and an evaluation unit that evaluates appropriateness of inspection of the quality state using the pseudo-image of the inspection image and calculates a plurality of evaluation values for each of the plurality of image processing algorithms, in which the inspection unit inspects the quality state of the article by applying an image processing algorithm selected based on the plurality of evaluation values.
(4) In a preferred embodiment of the present invention, a dataset to be used for training the trained model may include a dataset obtained by creating pseudo-images based on normal product sample images and automatically adding an OK tag to the pseudo-images.
(5) In a preferred embodiment of the present invention, a dataset to be used for training the trained model may include a dataset obtained by creating pseudo-images based on defective product sample images and automatically adding a defective product tag to the pseudo-images and a dataset obtained by creating pseudo-images based on defective part sample images and automatically adding a foreign object label to the pseudo-images.
(6) In a preferred embodiment of the present invention, the evaluation unit may evaluate whether or not normal product determination is executable with a probability greater than or equal to a predetermined correct answer rate and whether or not defective product determination is executable with a probability greater than or equal to a predetermined correct answer rate.

In this case, the plurality of image processing algorithms can be evaluated using multiple pseudo-images as simulated images of each of diverse inspection images, and any image processing algorithm appropriate for inspecting the quality state of the article is selected based on the evaluation value of each image processing algorithm. Thus, the article inspection device can increase the accuracy of the performance verification of the image processing algorithm without an effort to acquire the inspection image to be used for the performance verification.

### Advantage of the Invention

According to the present invention, an article inspection device capable of increasing accuracy of learning or performance verification without an effort to acquire an inspection image to be used for learning or performance verification for setting an inspection condition of article inspection can be provided.

### BRIEF DESCRIPTION OF THE DRAWINGS

FIG. 1 is a schematic configuration diagram illustrating an article inspection device according to one embodiment of the present invention.

FIG. 2 is a descriptive diagram of one example of a normal product group of a pseudo-image generated by an image generation AI by simulating the normal product group having diverse variation in postures or disposition of individual objects from an original image of a normal product sample to be used for training a learning model for determination in the article inspection device according to one embodiment of the present invention.

FIG. 3 is a descriptive diagram of one example of a defective product group of a pseudo-image generated by the image generation AI by simulating a shape defective product group having diverse variation in postures or disposition of individual objects from an original image of a shape defect sample to be used for training the learning model for determination in the article inspection device according to one embodiment of the present invention.

FIG. 4 is a descriptive diagram of one example of a foreign object group of a pseudo-image generated by the image generation AI by simulating diverse foreign objects from an original image of the foreign object group to be used for training the learning model for determination in the article inspection device according to one embodiment of the present invention.

FIG. 5 is a flowchart t illustrating a procedure of a schematic setting operation including model learning in the article inspection device according to one embodiment of the present invention.

FIG. 6 is a schematic configuration diagram illustrating an article inspection device according to another embodiment of the present invention.

### BEST MODE FOR CARRYING OUT THE INVENTION

Hereinafter, embodiments of the present invention will be described with reference to the drawings.

### One Embodiment

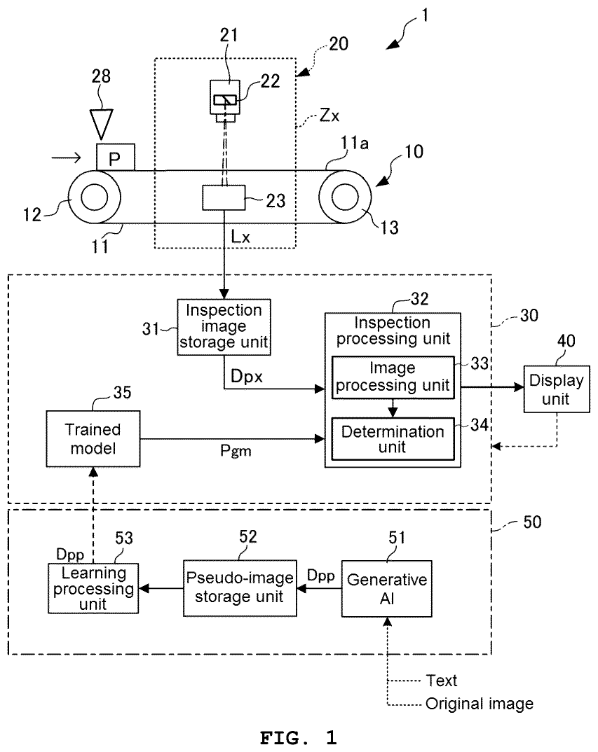

FIGS. 1 to 5 illustrate an article inspection device according to one embodiment of the present invention.

First, a configuration will be described.

As illustrated in FIG. 1, an article inspection device 1 of the present embodiment is provided with a transport unit 10 that transports an article P which is an inspection object, an inspection unit 20 having a function of imaging the article P being transported, a control unit 30 for main control including control of the transport unit 10 and the inspection unit 20, a display unit 40 such as a touch panel on which an operation can be input, and a learning unit 50 that causes the control unit 30 to execute predetermined machine learning. The article inspection device 1 detects image data corresponding to an X-ray transmission amount distribution while emitting, for example, an X-ray to the article P transported by the transport unit 10 using a conveyor, to image the article P via the inspection unit 20 and inspects a quality state of the article P based on the image data.

Here, the quality state is appropriateness of quality or a physical quantity required for the article P as a product. For example, the quality state is presence or absence of a contained foreign object, presence or absence of a missing product, appropriateness of a shape, a size, an accommodation state, and the like of contents, or distribution of a density, a thickness, a volume, or a mass.

The transport unit 10 is a conveyor that is obtained by winding a loop-shaped transport belt 11 around a driving-side transport roller 12 and a driven-side transport roller 13 and that transports, to the right in FIG. 1, the article P sequentially input into an upper traveling section 11a of the transport belt 11 from an upstream side and discharges the article P to a downstream side through an imaging section of the inspection unit 20. The transport unit 10 is supported by a casing (not illustrated).

The inspection unit 20 includes, for example, an X-ray generator (an X-ray source) 21 that generates an X-ray in a predetermined energy band transmitted through the article P transported by the transport unit 10, and an X-ray detector 23 disposed immediately below the upper traveling section 11a of the transport belt 11. The inspection unit 20 is not limited to acquiring an inspection image Dpx by emitting the X-ray to the article P and, for example, may use an exterior or transmission camera image using a near infrared ray (NIR) as the inspection image or use a color image obtained by imaging an exterior of the article using other types of light such as visible light as the inspection image.

The X-ray generator 21 generates the X-ray having a wavelength and an intensity corresponding to a tube current and a tube voltage of an X-ray tube 22 using the X-ray tube 22 and can emit a fan beam-shaped X-ray in a main observation direction orthogonal to an article transport direction of the transport unit 10, to the article P on the transport belt 11 through an X-ray window portion of an envelope (not illustrated in detail).

The X-ray detector 23 (not illustrated in detail) is configured with an X-ray line sensor camera that is obtained by disposing a detection element consisting of a scintillator as a phosphor and a photodiode or a charge-coupled element at a predetermined pitch in an array in a width direction of a transport path of the transport unit 10 and that outputs an X-ray detection signal Lx corresponding to a transmission amount with a predetermined resolution. The X-ray detector 23 is disposed at a predetermined position in the transport direction corresponding to an X-ray emission position from the X-ray generator 21.

That is, the inspection unit 20 can detect the X-ray emitted from the X-ray generator 21 and transmitted through the article P for each predetermined transmission region corresponding to the detection element, convert the X-ray into an electric signal corresponding to a transmission amount of the X-ray, and output the X-ray detection signal Lx for generating an X-ray transmission image in which a direction of transmission of the X-ray is an observation direction. The X-ray detector 23 sequentially outputs the X-ray detection signal Lx by executing main scanning in the width direction corresponding to a transport speed of the transport belt 11. In a case where an article detection sensor 28 detects the article P being placed on the transport belt 11 to be transported into a predetermined inspection section Zx, the X-ray detection signal Lx of the article P detected after an elapse of a predetermined time is output.

The control unit 30 has a function of transport control means for controlling the transport speed, a transport interval, and the like of the article P for the transport belt 11 in the transport unit 10, and a function of inspection control means for controlling an X-ray emission intensity and an emission period in the inspection unit 20 or controlling an X-ray detection cycle in the X-ray line sensor of the X-ray detector, a detection period of each article P, and the like corresponding to the transport speed of the article P.

The control unit 30 is configured to include, for example, a microcomputer (a processor) including a CPU, a ROM, a RAM, and an I/O interface (not illustrated), a program device that stores a control program for exhibiting each function of a plurality of functional units, described later, in the ROM, an auxiliary storage device, or other recording media in a readable manner or that downloads the control program from other computers through data communication, a timer circuit, and the like. The CPU executes predetermined calculation processing while exchanging data with the RAM or the like in accordance with the control program stored in the ROM or the like and executes the control program of the plurality of functional units.

The control unit 30 includes an inspection image storage unit 31, an inspection processing unit 32, and a trained model 35 as main functional units exhibiting the above function of the inspection control means, and the inspection processing unit 32 is configured to include an image processing unit 33 and a determination unit 34.

The inspection image storage unit 31 sequentially acquires the X-ray detection signal Lx from the X-ray detector 23 of the inspection unit 20, temporarily stores the image data indicating the X-ray transmission amount distribution of each article P in a memory, and outputs the image data as image data of the inspection image Dpx.

The image processing unit 33 of the inspection processing unit 32 sequentially acquires the image data of the inspection image Dpx output from the inspection image storage unit 31 and executes image analysis processing for extracting a global feature or a local feature of the image (for example, extracting a feature value of a local region based on a pixel value or a brightness gradient or extracting a frequency feature value of the whole image such as a spatial frequency spectrum) through one or more types of predetermined filter processing for which a parameter or a limit enabling extraction of an image feature is set. Here, the predetermined filter processing is filter processing of detecting or highlighting an image feature (for example, an edge or a blob) for which the quality state tends to deviate from a normal state, that is, a degree of the quality state is different from normality, using the above predetermined image processing algorithm.

The determination unit 34 of the inspection processing unit 32 executes inspection image processing enabling determination of presence or absence of a predetermined quality state of the article P using a predetermined image processing algorithm based on a result of image processing in the image processing unit 33.

The image processing unit 33 and the determination unit 34 of the inspection processing unit 32 also have a function of determining the presence or absence of the predetermined quality state of the article P by determining whether the quality state of the article P is normal or not normal using confidence, by exhibiting a function of cooperating with the trained model 35 to perform classification or abnormality detection (anomaly detection) through deep learning based on the inspection image Dpx of the article P acquired by the inspection image storage unit 31 or on the inspection image after the above predetermined filter processing. Here, the classification is processing of performing image class classification through which, for example, an article type of the inspection object can be specified by extracting a feature and learning a decision boundary in the input image. The abnormality detection (anomaly detection) is processing of detecting an abnormal part, for example, a partial missing of contents of the inspection object or an irregularity deviating from a normal range in the input image as an abnormality.

The trained model 35 is a program module (artificial intelligence software) constituting a neural network of multiple layers for causing the inspection processing unit 32 to exhibit the function of the classification function or the abnormality detection through deep learning based on the above inspection image or the inspection image after the predetermined filter processing, and the cooperation between the inspection processing unit 32 and the trained model 35 means acquiring an algorithm Pgm for inspection processing mainly based on a predetermined image processing algorithm in a memory of the inspection processing unit 32 as a program module from the trained model 35, and causing the program module to function to exhibit the above function of the classification or the abnormality detection.

In the trained model 35, in a learning phase, a feature of a normal product image is learned from image data of the normal product image not having an abnormality such as a foreign object as an image dataset for learning, or a defective product image and a feature of a defective part is further learned from image data of the defective product image having the defective part caused by the abnormality such as the foreign object, and image data of the defective part caused by the abnormality such as the foreign object.

Specifically, learning including inputting a predetermined number (for example, approximately 1000 or more) of images of a normal product for learning into the trained model 35, and adjusting a parameter such as a weight between the multiple layers of the neural network, for example, a weight of weighting in any j-th neuron of a hidden layer (an intermediate layer) with respect to any i-th neuron of an input layer and a weight of weighting in any k-th neuron of an output layer with respect to the any j-th neuron of the hidden layer is performed. Here, each of i, j, and k is any natural number.

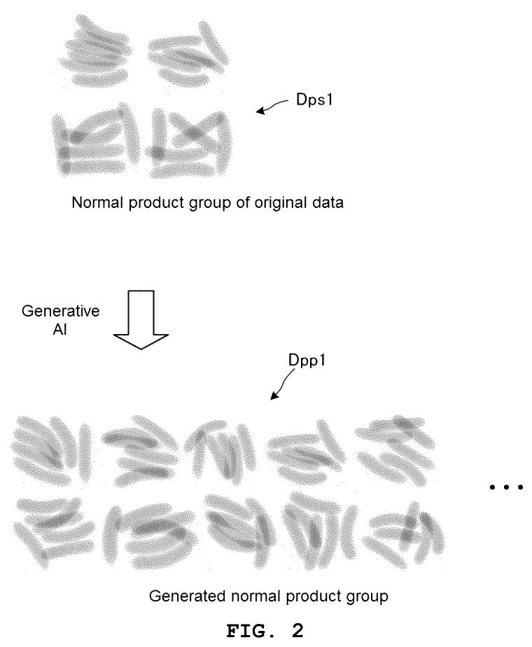

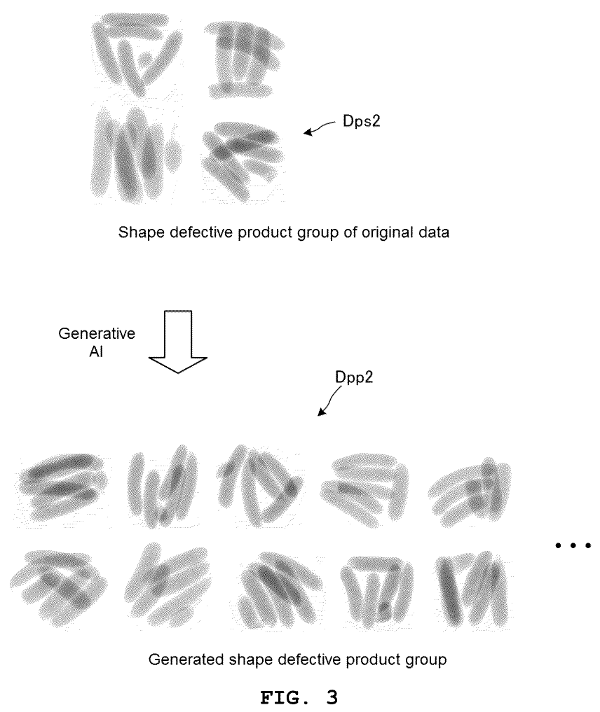

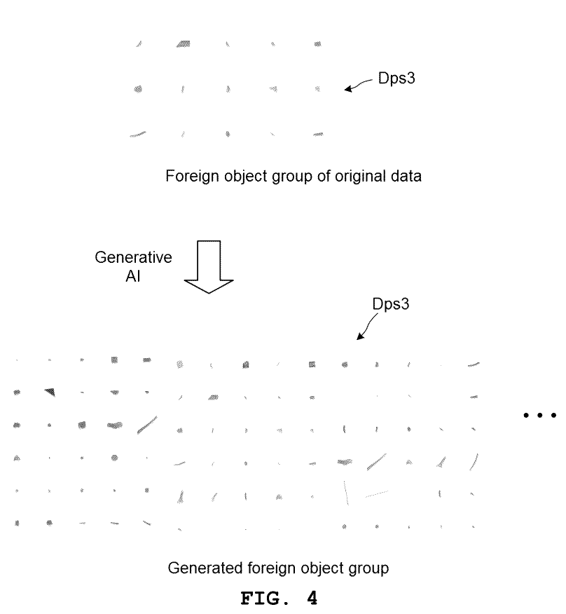

As illustrated in FIG. 2, the dataset to be used for training the trained model 35 is obtained by, for example, creating pseudo-images Dpp1 based on normal product sample images Dps1 and automatically adding an OK tag that may be used as information for image classification or anomaly detection, to the pseudo-images Dpp1. As illustrated in FIGS. 3 and 4, the dataset to be used for training the trained model 35 includes a dataset obtained by creating pseudo-images Dpp2 based on defective product sample images Dps2 and automatically adding a defective product tag for the image classification to the pseudo-images Dpp2, and a dataset obtained by creating pseudo-images Dpp3 based on defective part sample images Dps3 and automatically adding a category and a label of the defective part, for example, the foreign object, for object detection to the pseudo-images Dpp3.

In FIG. 1, the pseudo-images Dpp1 to Dpp3 are simply illustrated as a plurality of types of pseudo-images Dpp for convenience of illustration. However, in the following description, a dataset obtained by adding the OK tag to each pseudo-image Dpp1 of the predetermined number of normal products will be referred to as the dataset Dpp1. A dataset obtained by adding the defective product tag to each pseudo-image Dpp2 of the predetermined number of defective products will be referred to as the dataset Dpp2. A dataset obtained by adding the category and the label of the foreign object to each defective part sample image Dps3 of the predetermined number will be referred to as the dataset Dpp3.

In the trained model 35, the above parameter such as the weight between the layers is adjusted for image data of each article P for learning such that an output value of the neural network of the multiple layers is distributed in an attribute region of a normal product label in which a main feature value of each normal product image is distributed or in an attribute region of a defect label in which a main feature value of each defective product image is distributed in a feature space based on the above global feature or local feature of the image for each determination pixel region (may be one pixel) of a predetermined number of pixels of the inspection image that is a processing unit of inspection determination.

In a use phase, in a case where the image data of the inspection image Dpx of the normal product is input from the inspection image storage unit 31 into the inspection processing unit 32, the trained model 35 that is trained after adjusting the parameter specifies whether the inspection image Dpx and a center of distribution or a distribution pattern of the feature value (a feature vector) of each determination pixel region in the feature space based on the above global feature or local feature of the image is present in the attribute region of the normal product label in which the normal product image for learning is distributed or in the attribute region of the defect label in which the main feature value of each defective product image is distributed, using the output value of the neural network.

In a case where the trained model 35 also has a function of an object detection model, the trained model 35 may learn whether the inside of a rectangle on the image is an object or a background, and be trained to reduce an error between a category of the object in the rectangle and a correct answer label in a case where the object is present.

The learning unit 50 is configured to include a processor, for example, a graphics processing unit (GPU) or a visual processing unit (VPU), as a calculation module that exhibits a function of the image processing in cooperation with the CPU of the control unit 30 or independently, a program device that stores a control program for exhibiting a plurality of functions for learning in a ROM, an auxiliary storage device, or other recording media in a readable manner or that downloads the control program from other computers through data communication, a timer circuit, and the like. The learning unit 50 can execute the control program for exhibiting the plurality of functions for learning in accordance with the control program stored in the ROM or the like.

The learning unit 50 includes, as main functional units exhibiting the plurality of functions for learning, a generative AI 51 that is an image generation AI model, a pseudo-image storage unit 52 that stores a dataset of a pseudo-image generated by the generative AI 51, and a learning processing unit 53 that executes learning processing in the above learning phase of the trained model 35, for example, learning processing of adjusting the parameter such as the weight between the layers of each neuron, on the dataset of the pseudo-image stored in the pseudo-image storage unit 52.

The generative AI 51 is an image generation AI that generates the dataset to be used for training the trained model 35, for example, the dataset Dpp1 of a first pseudo-image obtained by adding the OK tag that may be used as the information for the image classification or the anomaly detection, to a pseudo-normal product image having a similar semantic feature (a feature vector in a multidimensional (hereinafter, referred to as n-dimensional) latent space) to the above normal product sample images Dps1, the dataset Dpp2 of a second pseudo-image obtained by adding the defective product tag for the image classification to a pseudo-defective product image having a similar semantic feature to the above defective product sample images Dps2, and the dataset Dpp3 of a third pseudo-image obtained by automatically adding the category and the label of the defective part, for example, the foreign object, for the object detection to a pseudo-defective part image having a similar semantic feature to the defective part sample images Dps3. Here, a degree of similarity between semantic feature vectors can be perceived from a magnitude of an inner product of a plurality of feature vectors to be compared in the n-dimensional latent space.

The generative AI 51 has, for example, an image classification model function of learning pair data between an input text (a prompt) and an image linked to semantic content of the text and estimating the degree of similarity between feature vectors of the image and the text, an encoder function of converting the input text into data of a feature vector linked to the semantic content of the text or compressing and converting the image input in accordance with a predetermined setting parameter into data of a multidimensional feature vector linked to semantic content of the image, a diffusion model function of using a multidimensional feature vector (a representation vector in the latent space) obtained by, for example, compressing the input image as an enumeration of latent variables and then executing a forward diffusion process 4 noising the enumeration and a reverse noise removal process, and a decoder function of generating an image through decoding based on the latent variables after the noise removal as an output image. Here, the predetermined setting parameter is, for example, a setting value corresponding to Prompt/Denoising strength for designating a degree to which an original image is maintained or noised in an image generation AI model “Stable Diffusion”, Number of Outputs for designating the number of generated images, Steps for designating the number of processing steps, Guidance Scale for adjusting the degree of similarity between the prompt and the generated image, and the like.

The generative AI 51 estimates the degree of similarity between the semantic feature vector of the output image output through decoding using the decoder function after the noise removal in the above diffusion model and the semantic feature vector corresponding to request content in the input text using the above image classification model function, generates one pseudo-image by repeatedly generating similar images until the degree of similarity reaches a threshold value for similarity determination (for example, the above setting value based on Prompt strength and Guidance Scale) set in advance or higher, and further repeatedly executes the generation of the pseudo-image of which the degree of similarity reaches the threshold value for the similarity determination set in advance or higher, until the number of images required for learning designated by the above predetermined setting parameter (for example, Number of Outputs) is reached.

The generative AI 51 is implemented after the image classification model function for a general image is sufficiently improved through prelearning, and a reference sample image and its supplementary description are input as the text and the original image.

For example, the generative AI 51 creates a variation image obtained by randomly changing a shape, a size, disposition, and the like of a segmentation image (for example, a pixel of each category assigned through semantic segmentation) of the original image within a predetermined restriction range that may be used as the product, based on the request content in the prompt, which is the input text, and creates the above datasets Dpp1 to Dpp3 of the first to third pseudo-images.

Accordingly, the above variation image generated by the generative AI 51 is obtained by diversely changing an occurrence position or a form of the defective part of the target product or disposition, a posture, a shape, a packaging form, or the like of the contents of the product as the whole image while randomly changing them for each individual object in the image in accordance with the request content in the prompt input as the text. Preprocessing that normalizes each image in the dataset to the same scale may also be performed.

The datasets Dpp1 to Dpp3 of the first to third pseudo-images generated by the generative AI 51 are sequentially accumulated and stored in the pseudo-image storage unit 52, and the first to third datasets Dpp1 to Dpp3 of the plurality of types of pseudo-images Dpp corresponding to the number of images required for learning stored in the pseudo-image storage unit 52 are used for training the trained model 35 by the learning processing unit 53.

Next, actions will be described.

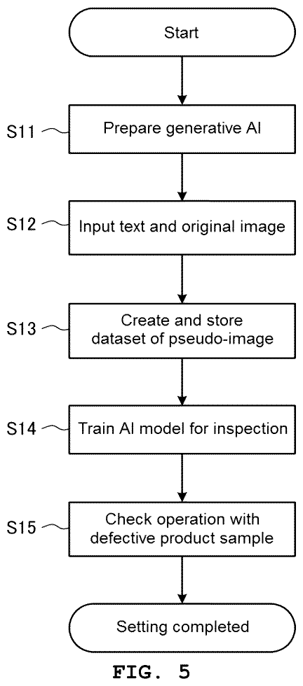

In the article inspection device 1 of the present embodiment configured as described above, a setting operation is executed through a schematic procedure illustrated in FIG. 5 before article inspection starts.

First, the program device of the image generative AI of which the general image classification model function is sufficiently improved through prelearning is introduced into the generative AI 51 of the learning unit 50, or a Web service of the image generation AI is enabled in the generative AI 51 of the learning unit 50 through an own PC, server, or the like connected to the learning unit 50 (step S11).

Next, the reference sample image of the image as the pseudo-image and its supplementary description are input into the generative AI 51 as the text and the original image, as illustrated in FIG. 1 (step S12), and the generative AI 51 creates the first to third datasets Dpp1 to Dpp3 of the plurality of types of pseudo-images Dpp by generating images (step S13).

Here, for example, the variation image obtained by randomly changing shapes, sizes, disposition, and the like of the segmentation images of the original images Dps1 to Dps3 within the predetermined restriction range that may be used as the product is created based on the request content in the prompt, and the datasets Dpp1 to Dpp3 of the first to third pseudo-images are sequentially stored in the pseudo-image storage unit 52.

Next, the datasets Dpp1 to Dpp3 of the first to third pseudo-images are used for training the trained model 35 by the learning processing unit 53. Accordingly, the parameter such as the weight of each neuron of the trained model 35 is effectively adjusted without bias, and the image classification function or the abnormality detection function of the trained model 35 for the inspection image Dpx is acquired with high accuracy (step S14).

After the parameter is adjusted, the image data of the inspection image Dpx of the article P is input from the inspection image storage unit 31 after the article type of the article P as an inspection target is set in the use phase of the trained model 35 that is trained.

Specifically, first, for example, in order to check an operation under an inspection condition of the inspection target article type, a test sample of defective product obtained by attaching a plurality of foreign object samples having different spherical diameters to an actual product of the inspection target article type is prepared. The test sample of defective product is placed and imaged by the inspection unit 20, and the image data of the inspection image Dpx is acquired by the inspection image storage unit 31. In a case where the image data of the inspection image Dpx is acquired in the inspection processing unit 32, the imaged test sample of defective product is determined as not being normal by the determination unit 34 of the inspection processing unit 32 in cooperation with the trained model 35, and it is understood that a required foreign object detection function is exhibited (step S15).

After the inspection condition of the inspection target article type is set and checked, setting is completed. Next, the article P which is the inspection object of the inspection target article type is sequentially placed and imaged at a predetermined transport interval or in transport distance units, and imaging data of the plurality of placed articles P is sequentially acquired in the inspection processing unit 32 from the inspection image storage unit 31 as the image data of the inspection image Dpx.

Here, in the inspection processing unit 32, whether or not each article P is in a normal quality state without the foreign object or a shape defect part is determined for the image data of the inspection image Dpx from the inspection image storage unit 31 by the determination unit 34 of the inspection processing unit 32 in cooperation with the trained model 35, an inspection result is displayed on the display unit 40, and a required article inspection function is exhibited.

In the present embodiment, since the dataset Dpp1 to Dpp3 of the first to third pseudo-images of the inspection image Dpx is generated by the generative AI 51 in order to set the inspection condition for the quality state of the article P, the request content in the prompt can be semantically changed with respect to the image by taking variation in size or shape including a fragmentation or distortion of the article P of the inspection target article type, variation such as diverse disposition and shapes of the contents or a shape, a size, or the like of the contained foreign object that cannot be predicted, a packaging defect form, or the like into consideration. Thus, the plurality of types of pseudo-images Dpp can be easily generated as simulated images of each of diverse inspection images (may be segmentation images), that is, images matching the request content. Accordingly, a dataset for learning having a wide range of variation corresponding to an actual change in form that cannot be obtained through data augmentation such as simple inversion, rotation, enlarging or reducing, translation, brightness change, or contrast change of the original image can be acquired from data of the original image effective for setting the inspection condition, and accuracy of learning or performance verification of the trained model 35 can be effectively increased.

In the present embodiment, the control unit 30 of the inspection unit 20 executes processing of inspecting the quality state of the article P by applying the trained model 35 as the inspection condition created by learning the pseudo-image Dpp. Accordingly, in the learning phase of the trained model 35, diverse variation in shape including a fragmentation, distortion, or the like of the inspection target product, diverse disposition or shapes of the contents of the inspection target product, furthermore, a shape, a size, or the like of the contained foreign object that cannot be predicted can be learned without bias, and required accuracy of the machine learning or the performance verification for the trained model 35 can be secured.

According to the present embodiment, the datasets Dpp1 to Dpp3 of the first to third pseudo-images generated by the generative AI 51 without bias in the learning phase of the trained model 35 are used for training the trained model 35 by the learning processing unit 53. Thus, the parameter such as the weight of each neuron of the trained model 35 is effectively adjusted without bias, and the image classification function and the abnormality detection function of the trained model 35 for the inspection image are secured with high accuracy.

Accordingly, the article inspection device 1 capable of increasing accuracy of learning or performance verification without an effort to acquire an inspection image to be used for learning or performance verification for setting an inspection condition of article inspection can be provided.

### OTHER EMBODIMENTS

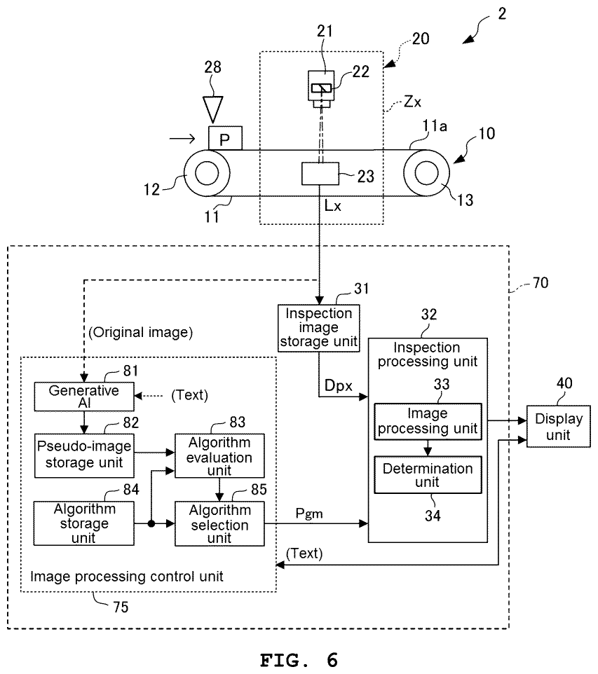

FIG. 6 illustrates a main configuration of an article inspection device according to another embodiment of the present invention.

An article inspection device 2 of the other embodiment illustrated in FIG. 6 has a similar configuration to the article inspection device 1 of the one embodiment. Thus, similar configuration parts will be designated by the same reference numerals as the constituents corresponding to the one embodiment, and duplicate descriptions of the contents will be omitted.

The article inspection device 2 of the present embodiment includes a control unit 70 for main control including control of the transport unit 10 and the inspection unit 20, and in the control unit 70, the inspection image storage unit 31, the inspection processing unit 32, and an image processing control unit 75 that supplies the algorithm Pgm (the program module including the image processing algorithm) for the inspection processing to the inspection processing unit 32 in a switchable manner.

Specifically, the image processing control unit 75 includes a generative AI 81, a pseudo-image storage unit 82, an algorithm evaluation unit 83, an algorithm storage unit 84, and an algorithm selection unit 85.

The generative AI 81 can receive input of the prompt, which is input as the text, from the display unit 40 such as the touch panel on which an operation can be input, receive input of the image data of the normal product sample and/or the image data of the defective product (may include only the defective part) sample imaged by the inspection unit 20 from the X-ray detector 23 in the form of the X-ray detection signal Lx, and normalize the image data to the same scale and number of gray levels as the inspection image Dpx output from the inspection image storage unit 31.

The generative AI 81 has the same image classification model function, encoder function, diffusion model function, and decoder function as the generative AI 51 of the one embodiment and estimates the degree of similarity between the semantic feature vector of the output image output through decoding using the decoder function after the noise removal in the above diffusion model and the feature vector corresponding to the request content in the input text using the above image classification model function, generates one similar image by repeatedly generating similar images until the degree of similarity reaches the threshold value for similarity determination set in advance or higher, and further repeatedly executes the generation of the similar image until the number of images of which the degree of similarity reaches the threshold value for the similarity determination set in advance or higher reaches the number of images required for learning designated by the above predetermined setting parameter, for example, Number of Outputs.

The image data of the normal product sample and/or the image data of the defective product (may include only the defective part) sample of the number of images required for learning is input into the generative AI 81 as the original image, and the prompt input as the text from the display unit 40 such as the touch panel on which an operation can be input is input into the generative AI 81 as the request contents that diversely change the occurrence position or the form of the defective part of the target product or the disposition, the posture, the shape, the packaging form, or the like of the contents of the product as the whole image while randomly changing them for each individual object in the image.

Here, the variation images generated by the generative AI 81 in accordance with the original image and the prompt are sequentially stored in the pseudo-image storage unit 82 and are maintained in a storage state readable by the algorithm evaluation unit 83.

The algorithm evaluation unit 83 sequentially reads a plurality of rule-based algorithms for the inspection processing mainly based on the image processing algorithm included in an inspection algorithm of the article inspection device 2 from the algorithm storage unit 84, and based on the variation image generated by the generative AI 81 in accordance with the original image and the prompt, evaluates (sensitivity evaluation) whether or not the read algorithm for the inspection processing can execute determination of the correct answer label, that is, normal product determination, for the pseudo-normal product images of the predetermined number corresponding to the above dataset Dpp1 of the first pseudo-image with a probability greater than or equal to a predetermined correct answer rate and/or evaluates (sensitivity evaluation) whether or not the read algorithm for the inspection processing can execute determination of the correct answer label, that is, defective product determination, for the pseudo-defective product images of the predetermined number corresponding to the above dataset Dpp2 of the second pseudo-image with a probability greater than or equal to a predetermined correct answer rate.

The algorithm storage unit 84 stores each of the plurality of rule-based algorithms for the inspection processing usable in the inspection processing unit 32, for example, a plurality of types of algorithms for the inspection processing such as a foreign object detection algorithm and a missing detection algorithm, in an identifiable manner for each type using a plurality of algorithm numbers and has a storage capacity such that the plurality of algorithms for the inspection processing are stored and maintained to be addable or updatable as a part of the inspection algorithm of the article inspection device 2.

In a case where a new article type is selected and set or a request for the performance verification of a specific inspection processing algorithm is made from the display unit 40, the algorithm selection unit 85 can select the algorithm Pgm for the inspection processing optimal for the article type or an article type group of the inspection target in accordance with a result of evaluating whether or not the inspection processing can be performed with the predetermined correct answer rate or higher for any type or the specific algorithm for the inspection processing stored in the algorithm storage unit 84 via the algorithm evaluation unit 83 based on the datasets of the plurality of types of pseudo-images Dpp stored in the pseudo-image storage unit 82.

The algorithm selection unit 85 can further replace the algorithm for the inspection processing implemented in the image processing unit 33 of the inspection processing unit 32 with the algorithm for the inspection processing selected by the algorithm selection unit 85 as the optimal algorithm. Accordingly, the image processing control unit 75 can verify performance of the image processing and determination processing of the inspection processing unit 32.

The article inspection device 2 of the present embodiment includes the algorithm storage unit 84 (an image processing algorithm storage unit) that stores, in advance, the algorithm for the inspection processing mainly based on a plurality of image processing algorithms, and the algorithm evaluation unit 83 (an evaluation unit) that evaluates the appropriateness of inspection of the quality state with the correct answer rate of a determination label using the datasets of the plurality of types of pseudo-images Dpp for the plurality of algorithms for the inspection processing and calculates the correct answer rate of determination as a plurality of evaluation values indicating evaluation results of each of the plurality of inspection processing algorithms, in which the inspection unit 20 can inspect the quality state of the article P as the inspection target by applying the algorithm Pgm for the inspection processing selected and set by the algorithm selection unit 85 based on the plurality of evaluation values obtained by the algorithm evaluation unit 83.

Accordingly, in the present embodiment, the plurality of image processing algorithms can be evaluated using the plurality of types of (multiple) pseudo-images Dpp as simulated images of each of diverse inspection images, and the algorithm Pgm for the inspection processing including any image processing algorithm appropriate for inspecting the quality state of the article P can be selected and set based on the evaluation value (the correct answer rate of determination) of each image processing algorithm. Thus, the accuracy of the performance verification of the algorithm Pgm for the inspection processing can be increased without an effort to acquire the inspection image to be used for the performance verification.

In the present embodiment, as in the one embodiment, an article inspection device capable of increasing accuracy of learning or performance verification without an effort to acquire an inspection image to be used for learning or performance verification for setting an inspection condition of article inspection can be provided.

In each of the above embodiments, each of the generative AI 51 and the generative AI 81 receives input of the text and the image. However, it is also conceivable to input only the prompt into the generative AIs 51 and 81 as the text depending on processing contents of the inspection processing unit 32 and the image classification model functions of the generative AIs 51 and 81 in a pretrained state. In this case, the request contents of an image classification task in the prompt may be set in more detail in accordance with a product form. The image generation AI model used as the generative AI 51 and the generative AI 81 is not limited to a specific model. While the generative AI 81 in the other embodiment is described as being incorporated into the control unit 70 to be implemented, the generative AI 81 may also be disposed outside the control unit 70, like the generative AI 51 in the one embodiment.

As described above, the present invention can provide an article inspection device capable of increasing accuracy of learning or performance verification without an effort to acquire an inspection image to be used for learning or performance verification for setting an inspection condition of article inspection. The present invention is useful for all article inspection devices that inspect a quality state of an article using an inspection image obtained by imaging an inspection object and a learning model or an inspection algorithm.

### DESCRIPTION OF REFERENCE NUMERALS AND SIGNS

1, 2: Article inspection device
10: Transport unit
11: Transport belt
11a: Upper traveling section
12: Transport roller
13: Transport roller
20: Inspection unit (imaging unit)
21: X-ray generator (x-ray source)
22: X-ray tube
23: X-ray detector
28: Article detection sensor
30: Control unit
31: Inspection image storage unit (inspection image acquisition unit)
32: Inspection processing unit
33: Image processing unit
34: Determination unit
35: Trained model (artificial intelligence software, program module)
40: Display unit (touch panel)
50: Learning unit
51, 81: Generative AI (image generation AI model, artificial intelligence software)
52, 82: pseudo-image storage unit
53: Learning processing unit
70: Control unit
75: Image processing control unit
83: Algorithm evaluation unit
84: Algorithm storage unit
85: Algorithm selection unit
Dpp: Plurality of types of pseudo-images
Dpp1: Pseudo-image (first pseudo-image, dataset of first pseudo-image)
Dpp2: Pseudo-image (second pseudo-image, dataset of second pseudo-image)
Dpp3: Pseudo-image (third pseudo-image, dataset of third pseudo-image)
Dps1: Sample image (normal product sample image, original image)
Dps2: Defective product sample image (original image)
Dps3: Defective part sample image (original image)
Dpx: Inspection image
Lx: X-ray detection signal
P: Article (inspection object)
Pgm: Algorithm for inspection processing (image processing algorithm, program module)
Zx: Predetermined inspection section

What is claimed is:

1. An article inspection device comprising:
an inspection unit that inspects a quality state of an article (P) using an inspection image (Dpx) obtained by imaging the article being transported,
wherein the inspection unit sets an inspection condition of the quality state of the article based on a pseudo-image (Dpp) of the inspection image generated by a generative AI.

2. The article inspection device according to claim 1,
wherein the inspection unit sets the inspection condition using a trained model created by learning the pseudo-image.

3. The article inspection device according to claim 1, further comprising:
an image processing algorithm storage unit that stores a plurality of image processing algorithms in advance; and
an evaluation unit that evaluates appropriateness of inspection of the quality state using the pseudo-image of the inspection image and calculates a plurality of evaluation values for each of the plurality of image processing algorithms,
wherein the inspection unit inspects the quality state of the article by applying an image processing algorithm (Pgm) selected based on the plurality of evaluation values.

4. The article inspection device according to claim 2, further comprising:
an image processing algorithm storage unit that stores a plurality of image processing algorithms in advance; and
an evaluation unit that evaluates appropriateness of inspection of the quality state using the pseudo-image of the inspection image and calculates a plurality of evaluation values for each of the plurality of image processing algorithms,
wherein the inspection unit inspects the quality state of the article by applying an image processing algorithm (Pgm) selected based on the plurality of evaluation values.

5. The article inspection device according to claim 2,
wherein a dataset to be used for training the trained model includes a dataset obtained by creating pseudo-images (Dpp1) based on normal product sample images (Dps1) and automatically adding an OK tag to the pseudo-images.

6. The article inspection device according to claim 2,
wherein a dataset to be used for training the trained model includes a dataset obtained by creating pseudo-images (Dpp2) based on defective product sample images (Dps2) and automatically adding a defective product tag to the pseudo-images and a dataset obtained by creating pseudo-images (Dpp3) based on defective part sample images (Dps3) and automatically adding a foreign object label to the pseudo-images.

7. The article inspection device according to claim 3,
wherein the evaluation unit evaluates whether or not normal product determination is executable with a probability greater than or equal to a predetermined correct answer rate and whether: or not defective product determination is executable with a probability greater than or equal to a predetermined correct answer rate.
